(19) United States
(12) Patent Application Publication
(10) Pub. No.: US 2004/0169019 A1
(43) Pub. Date: Sep. 2, 2004

(54) Protective gas for the non-vacuum electron-beam welding of metallic materials

(76) Inventor: Bernd Hildebrandt, Tonisvorst (DE)

Correspondence Address: CONNOLLY BOVE LODGE & HUTZ, LLP, P.O. BOX 2207, WILMINGTON, DC, 19899-2207, US

(21) Appl. No.: 10/726,009

(22) Filed: Dec. 2, 2003

(30) Foreign Application Priority Data
Dec. 5, 2002 (DE) 102 56 779.4

(51) Int. Cl. B23K 15/10

(52) U.S. Cl. 219/121.24; 219/121.14; 252/372

(57) ABSTRACT

The protective gas according to the invention for the non-vacuum electron-beam welding of metallic materials, particularly light metals in automotive production, consisting of a cold gas in the form of inexpensive nitrogen or helium, allows cost-effective as well as high-quality processing of the materials.

The invention relates to a protective gas for the non-vacuum electron-beam welding of metallic materials, particularly light metals.

Helium, which has been used up until now as the protective gas in the non-vacuum electron-beam welding (NV-EBW) of metallic materials, particularly light metals such as aluminum in automotive production, and which is employed at a temperature that corresponds to the ambient temperature, is only available in limited amounts, as a result of which its use is expensive.

With this in mind, the invention is based on the objective of providing a protective gas for the non-vacuum electron-beam welding of metallic materials, particularly light metals, that allows cost-effective as well as high-quality processing of the materials.

This objective is achieved according to the invention by means of a protective gas consisting of cold gas.

A low-reactivity gas, advantageously inexpensive nitrogen (evaporation temperature of −196° C. [−320.8° F.]) or an inert gas, preferably helium (boiling temperature of −269° C. [−452.2° F.]), is employed according to the invention as the cold gas.

The protective gas according to the invention, consisting of cold gas, for the non-vacuum electron-beam welding of metallic materials, particularly light metals such as aluminum in automotive production, allows cost-effective as well as high-quality processing of the materials.

Moreover, the use according to the invention of cold-gas protective gas in the non-vacuum electron-beam welding of metallic materials accounts for better focusing properties of the beam because of the reduced particle movement.

1. A protective gas consisting of a cold gas for the non-vacuum electron-beam welding of metallic materials, particularly light metals.

2. The protective gas according to claim 1, characterized in that the cold gas consists of inert gas.

3. The protective gas according to claim 2, characterized in that the inert gas is preferably helium.

4. The protective gas according to claim 1, characterized in that the cold gas consists of a low-reactivity gas.

5. The protective gas according to claim 4, characterized in that the cold gas is nitrogen.

6. The use of the protective gas for the non-vacuum electron-beam welding of metallic materials, particularly light metals in automotive production.
